(19) United States
(12) Patent Application Publication
(10) Pub. No.: US 2019/0309854 A1
(43) Pub. Date: Oct. 10, 2019

(54) Articulated Seal Ring Assemblies

(71) Applicant: Cameron International Corporation, Houston, TX (US)

(72) Inventors: Kody Carrillo, Cypress, TX (US); Brian Matteucci, Houston, TX (US)

(21) Appl. No.: 15/950,144

(22) Filed: Apr. 10, 2018

(51) Int. Cl. F16J 15/3284

(52) U.S. Cl. CPC F16J 15/3284

(57) ABSTRACT

Valves with articulated seal ring assemblies are provided. In one embodiment, a valve includes a hollow body having an inlet port and an outlet port in fluid communication with an inner chamber of the hollow body, a piston disposed within the inner chamber of the hollow body, and an articulated seal ring assembly carried by the piston. The articulated seal ring assembly includes a shear seal ring that is seated against an interior surface within the hollow body and is coupled to the piston via a joint that facilitates pivoting of the shear seal ring with respect to the piston. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often employed to access and extract the resource. These systems may be located onshore or offshore depending on the location of a desired resource.

Further, such systems generally include a wellhead assembly through which the resource is accessed or extracted. These wellhead assemblies may include a wide variety of components, such as various casings, valves, fluid conduits, blowout preventers, and the like, that control drilling or production operations. Control systems, such as subsea control pods, can be used to operate hydraulic components and manage flow through the assemblies. When a particular hydraulic function is to be performed (e.g., closing a ram of a blowout preventer), a control valve associated with the hydraulic function can be opened to supply control fluid to the component responsible for carrying out the hydraulic function (e.g., a piston of the blowout preventer). Other valves, such as pressure regulators, can also be used to control flow of fluid within these control systems. Further, such control valves and other valves could also be used to control flow of various fluids in other applications.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Some embodiments of the present disclosure generally relate to valves having articulated seal ring assemblies. In certain embodiments, for example, a valve includes a piston that carries articulated seal ring assemblies for controlling flow through the valve. The articulated seal ring assemblies, which can include shear seal rings and seal ring carriers, are coupled to the piston via joints that allow the shear seal rings to pivot with respect to the piston to facilitate sealing of the shear seal rings against shear seal plates or other surfaces within the valve. In some instances, the articulated seal ring assemblies include separate or integral bearings that facilitate pivoting of the shear seal rings with respect to the piston. And in at least some embodiments, the shear seal rings can pivot independently of one another.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts an offshore apparatus for accessing or extracting a resource, such as oil or natural gas, via a well in accordance with one embodiment of the present disclosure;

FIG. 2 is a block diagram of various components of stack equipment of the offshore apparatus of FIG. 1, including hydraulic components operated with valves in accordance with one embodiment;

FIGS. 3 and 4 are perspective views of a pressure regulator in accordance with one embodiment;

FIG. 5 is a longitudinal cross-section of the pressure regulator of FIG. 3 and shows the pressure regulator having articulated seal ring assemblies carried by a piston in accordance with one embodiment;

FIG. 6 is a lateral cross-section of the pressure regulator of FIG. 3 in accordance with one embodiment;

FIG. 7 is a detail view of two of the articulated seal ring assemblies of FIG. 5 and shows the articulated seal ring assemblies as having shear seal rings carried by seal ring carriers that pivot about bearings within sockets of the piston in accordance with one embodiment;

FIGS. 8 and 9 are detail views of articulated seal ring assemblies including seal ring carriers with integral bearings for pivoting with respect to the piston in accordance with certain embodiments;

FIG. 10 is a detail view of articulated seal ring assemblies including shear seal rings shaped to facilitate pivoting of the shear seal rings within sockets of the piston without seal ring carriers in accordance with one embodiment;

FIG. 11 is a detail view of articulated seal ring assemblies having seal ring carriers with recessed portions for pivoting about hubs mounted on the piston in accordance with one embodiment; and

FIG. 12 generally depicts a valve having an internal piston carrying rotationally offset pairs of seal ring assemblies in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

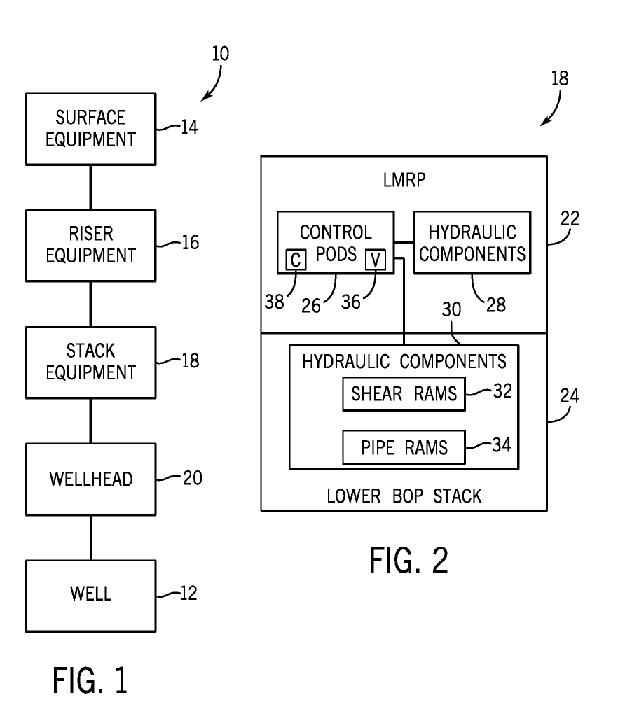

Turning now to the present figures, a well assembly or apparatus 10 is illustrated in FIG. 1 in accordance with one embodiment. The apparatus 10 (e.g., a drilling system or a production system) facilitates access to or extraction of a resource, such as oil or natural gas, from a reservoir through a well 12. The apparatus 10 is generally depicted in FIG. 1 as an offshore apparatus that includes surface equipment 14, riser equipment 16, and stack equipment 18 for accessing or extracting the resource from the well 12 via a wellhead 20. In one subsea drilling application, the surface equipment 14 is mounted to a drilling rig above the surface of the water, the stack equipment 18 (i.e., a wellhead assembly) is coupled to the wellhead 20 near the sea floor, and the riser equipment 16 connects the stack equipment 18 to the surface equipment 14. Although shown here as an offshore apparatus, the well apparatus 10 could instead be an onshore system in other embodiments.

The surface equipment 14 may include a variety of devices and systems, such as pumps, power supplies, cable and hose reels, control units, a diverter, a gimbal, a spider, and the like. Similarly, the riser equipment 16 may also include a variety of components, such as riser joints, flex joints, a telescoping joint, fill valves, and control units, to name but a few examples. The stack equipment 18, in turn, may include a number of components, such as blowout preventers and control systems, that enable control of fluid from the well 12.

In one embodiment generally depicted in FIG. 2, the stack equipment 18 includes a lower marine riser package (LMRP) 22 coupled to a lower blowout preventer (BOP) stack 24. The lower marine riser package 22 includes a control system, provided in the form of control pods 26 in FIG. 2, for controlling hydraulic components 28 and 30. The components 28 and 30 perform various hydraulic functions on the stack equipment 18, including controlling flow from the well 12 through the stack equipment 18. In the depicted embodiment, the components 30 of the lower blowout preventer stack 24 include hydraulically controlled shear rams 32 and pipe rams 34 (of ram-type blowout preventers). But it will be appreciated that the stack equipment 18 may include many hydraulic functions that would be performed by the hydraulic components 28 and 30. By way of example, in various embodiments the hydraulic components 28 and 30 collectively include annular blowout preventers, other ram-type blowout preventers, and other valves.

The control pods 26 are connected to the components 28 and 30 by suitable conduits (e.g., control tubing or hoses). This allows the control pods 26 to route hydraulic control fluid to the components 28 and 30 to cause these components to perform their intended functions, such as closing the rams of a blowout preventer or opening a valve. The hydraulic control fluid may be routed to the components 28 and 30 via valves 36. Such valves 36 can include control valves operated by a controller 38 (e.g., a subsea electronics module that controls operation of the control valves based on received command signals). In some instances, one or more of the valves 36 may be provided in the form of a pressure regulator.

More particularly, in at least some embodiments the valves 36 include a pressure regulator and control valves (e.g., solenoid valves) that control flow to hydraulic components 28 and 30, with the pressure regulator and the control valves arranged such that the pressure regulator receives an initial supply pressure from a source of pressurized fluid (e.g., an accumulator bank) and delivers a regulated pressure to the control valves. The initial supply pressure may exceed the pressure rating of the control valves, and the pressure regulator can be used to provide a regulated pressure to the control valves (or other downstream components) that is below their pressure ratings. In at least some embodiments, multiple pressure regulators are used to provide control fluid to downstream components. The multiple pressure regulators could each provide control fluid at the same regulated pressure, or the multiple pressure regulators could be configured such that two or more pressure regulators provide control fluid at different regulated pressures. And while the valves 36 of the presently illustrated embodiment are depicted as components of the stack equipment 18 in FIG. 2, it will be appreciated that various valves 36 (e.g., pressure regulators and control valves) may be disposed in other portions of the system 10, such as components of the surface equipment 14, in other embodiments in full accordance with the present techniques.

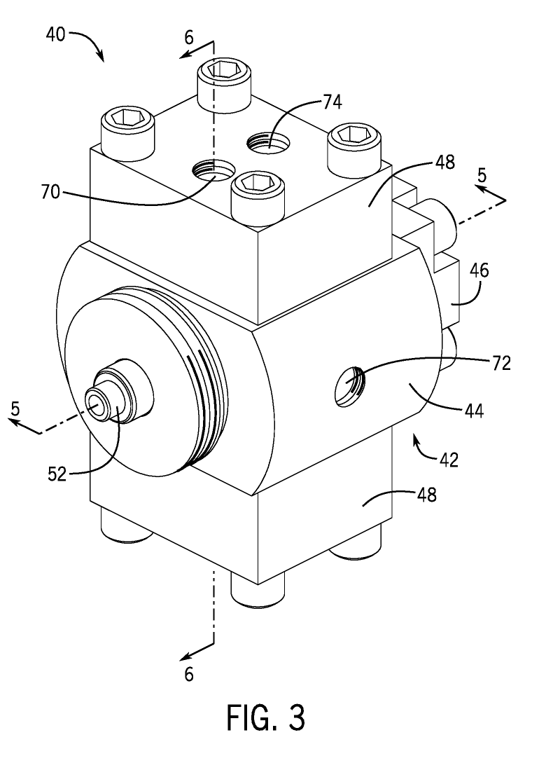

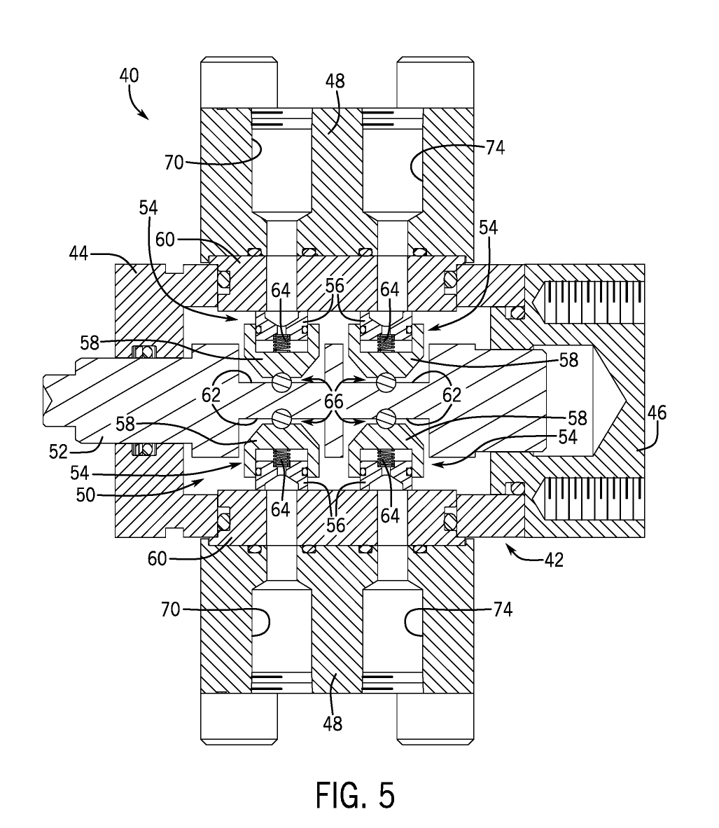

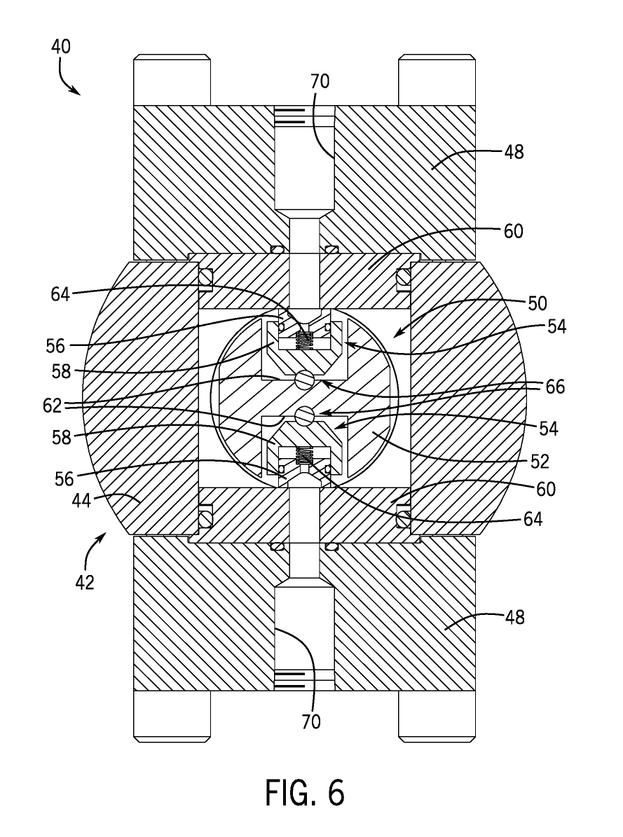

An example of a valve 36 in the form of a pressure regulator 40 is depicted in FIGS. 3-7 in accordance with one embodiment. The depicted pressure regulator 40 includes a hollow body 42 having a main body 44, with an end cap 46 and connection blocks 48 fastened to the main body 44. As shown in FIGS. 5 and 6, the hollow body 42 includes an inner chamber 50 for receiving a moveable carriage assembly having a piston 52 carrying articulated seal ring assemblies 54 that include shear seal rings 56 and seal ring carriers 58. As discussed in greater detail below, the shear seal rings 56 are seated against shear seal plates 60 such that the shear seal rings 56 slide along and seal against the shear seal plates 60 to facilitate the control of flow through the pressure regulator 40 via reciprocal movement of the piston 52. In at least some embodiments, including as depicted in FIGS. 5 and 6, the articulated seal ring assemblies 54 are carried in cavities 62 (which may also be referred to as sockets) in the piston 52. Springs 64 bias the seal rings 56 radially outward from the piston 52 against the seal plates 60, and joints 66 permit rotation of the articulated seal ring assemblies 54 with respect to the piston 52 to facilitate sealing.

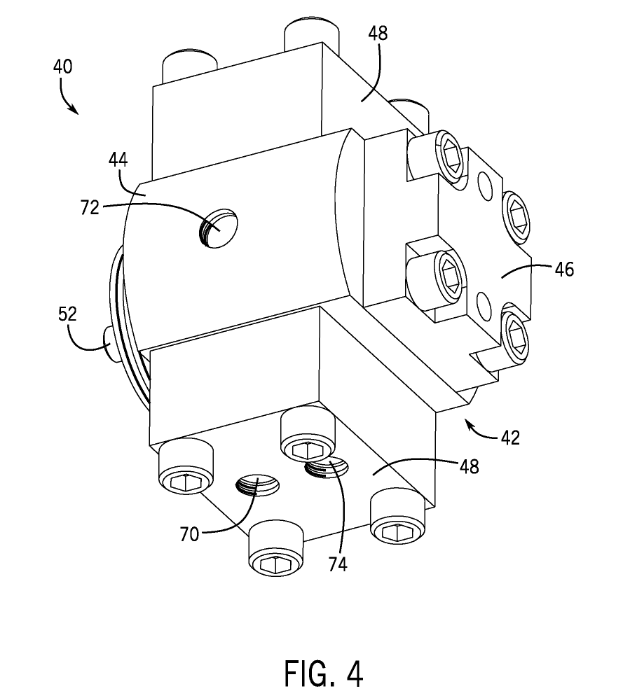

During operation, a control medium at a first (supply) pressure, such as a pressure of 3000-5000 psi, may enter the pressure regulator 40 through supply ports 70 and the control medium may be output at a second, regulated pressure, such as a pressure of 200-3000 psi, via at least one regulated-pressure outlet port 72. One such regulated-pressure outlet port 72 is depicted in FIGS. 3 and 4 in a side of the main body 44, but it will be appreciated that the pressure regulator 40 may include one or more additional regulated-pressure outlet ports 72, such as an additional outlet port 72 on the opposite side of the main body 44. Additionally, if the pressure inside the pressure regulator 40 exceeds a certain upper threshold, the control medium may be vented from the regulator 40 through vent ports 74.

The pressure regulator 40 can be spring-loaded, such as by one or more springs (not shown) positioned to bias the piston 52 against fluid pressure (e.g., by pushing the protruding end of the piston 52 in FIG. 5 to the right). For example, a housing including the one or more springs could be attached to the threaded end of the main body 44 depicted in FIG. 3 so that the one or more springs apply a biasing force to the end of the piston 52 protruding from the main body 44. The amount of biasing force provided by such springs can be controlled in various manners, such as with a moveable plunger for varying the amount of compression on the springs.

During operation, fluid pressure within the inner chamber 50 applies a thrust force that causes the piston 52 to move axially within the inner chamber 50 against this biasing force such that the seal rings 56 slide along the seal plates 60 and control flow through the inner chamber 50. The pressure regulator 40 is arranged such that the seal rings 56 do not seal the supply ports 70 when the pressure within the inner chamber 50 is below a lower pressure threshold (e.g., a desired operating pressure for control valves or other downstream components). This allows control fluid to flow into the inner chamber 50 through the supply ports 70 and then out from the inner chamber 50 through the outlet ports 72. The piston 52 moves in response to fluid pressure within the inner chamber 50 and, when the pressure within the inner chamber 50 exceeds the lower pressure threshold, the piston 52 positions two of the seal rings 56 to seal against the seal plates 60 about the supply ports 70 and prevent flow into the inner chamber 50. Other seal rings 56 prevent flow out of the inner chamber 50 through the vent ports 74 until the pressure within the inner chamber 50 exceeds an upper pressure threshold, greater than the lower pressure threshold, and causes the piston 52 to move such that the other seal rings 56 no longer seal against the seal plates 60 about the vent ports 74. This allows excess pressure to escape from the inner chamber 50 through the vent ports 74. Although the seal rings 56 for closing the supply ports 70 can be the same size as those for closing the vent ports 74, in at least some embodiments the seal rings 56 for closing the supply ports 70 are of a different size (e.g., smaller in diameter across their sealing faces) than those for closing the vent ports 74.

The pressure regulator 40 may also include various o-rings or other seals for maintaining pressure within the regulator 40 and preventing leakage. In at least some embodiments, the pressure regulator 40 is a hydraulic pressure regulator and the control medium includes hydraulic fluid. In other embodiments, however, the control medium may be some other material, such as a pressurized gas. And while the presently depicted pressure regulator 40 includes two supply ports 70 and two vent ports 74, with corresponding seal ring assemblies 54 arranged on two opposing sides of the piston 52 to selectively close these supply and vent ports 70 and 74, other embodiments could have some other number of seal ring assemblies 54, supply ports 70, and vent ports 74 in full accordance with the present techniques.

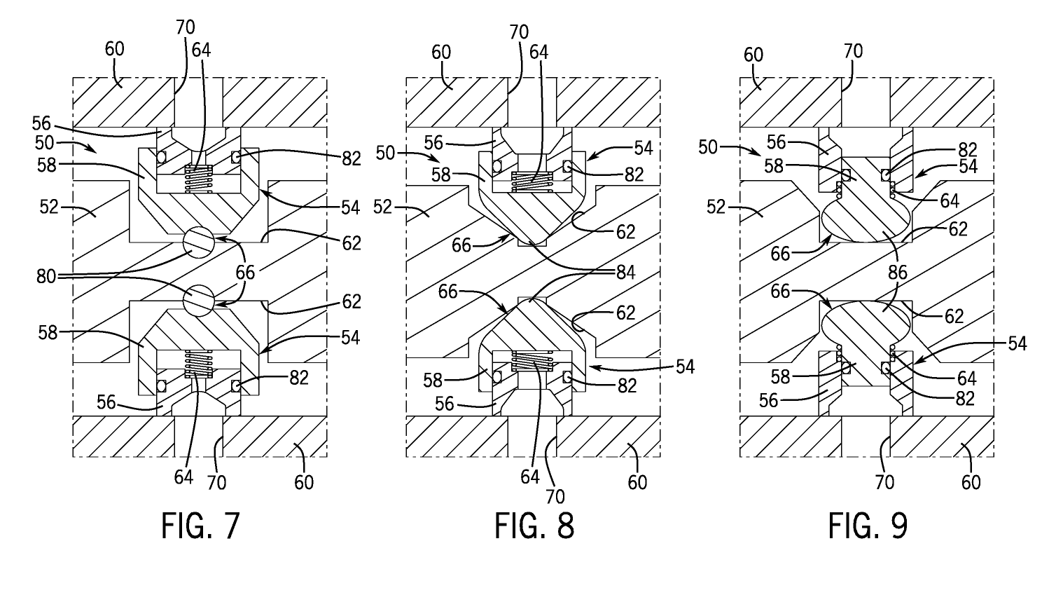

A detail view of two seal ring assemblies 54 carried by the piston 52 is provided in FIG. 7. Although these two seal ring assemblies 54 are shown positioned along the supply ports 70, it will be appreciated that the seal ring assemblies 54 for selectively closing the vent ports 74 may be similarly constructed. In the embodiment depicted in FIG. 7, the seal ring assemblies 54 include seal rings 56 that are received within bores of the seal ring carriers 58 and are biased against opposing seal plates 60 by the springs 64.

The sealing surfaces of one or more seal plates 60 (i.e., the surfaces that the seal rings 56 slide along and seal against) may generally be parallel with each other and with the longitudinal axis of travel of the piston 52 and perpendicular to the direction of radial bias applied to the seal rings 56 by the springs 64. In some instances, however, the internal components of the pressure regulator 40 may be misaligned. There may be misalignment between the seal rings 56 and the seal plates 60, or the piston 52 may be rotationally misaligned with respect to the seal plates 60, for example. Manufacturing tolerances or wear can also contribute to misalignment of certain components, such as the piston 52 with respect to the main body 44 or the end cap 46. Further, such misalignment could inhibit proper sealing of the seal rings 56 against the seal plates 60.

In at least some embodiments, however, the pressure regulator 40 (or other valve 36) includes articulated seal ring assemblies 54 with joints 66 that enable the seal rings 56 to pivot to compensate for possible misalignment of internal components. For instance, as depicted in greater detail in FIG. 7, the seal ring assemblies 54 include seal rings 56 that are coupled to the piston 52 via seal ring carriers 58 and bearings 80 that are installed between the seal ring carriers 58 and the piston 52. In the embodiment shown in FIG. 7, the springs 64 are positioned within the seal ring carriers 58 to bias the seal rings 56 toward sealing engagement with the seal plates 60, and seals 82 (e.g., o-rings) are provided about the seal rings 56 to prevent fluid leakage along the exterior of the seal rings 56. The bearings 80 facilitate pivoting of the seal ring carriers 58 (with their carried seal rings 56) about the bearings 80. In at least some embodiments the bearings 80 are ball bearings that allow the seal ring carriers 58 to pivot with three degrees of rotational freedom. In other embodiments, however, the bearings 80 could be configured to provide fewer degrees of rotational freedom, such as cylindrical bearings providing one degree of rotational freedom. Each seal ring assembly 54 can be coupled to the piston 52 with its own joint 66 (e.g., the interfacing bearings 80 and seal ring carriers 58) to enable each seal ring assembly 54 to pivot independently of the other seal ring assemblies 54 to facilitate sealing of the seal rings 56 against the seal plates 60. That is, with the piston 52 having the seal ring assemblies 54 received in the hollow body 42 of the pressure regulator 40, the seal ring assemblies 54 can pivot independently with respect to the piston 52 during operation to facilitate sealing engagement of the seal rings 56 with opposing sealing surfaces (e.g., seal plates 60).

In other embodiments, the joints 66 include integral bearings of seal ring carriers 58. As generally depicted in FIGS. 8 and 9 by way of example, the seal ring carriers 58 can include bearings in the form of curved surfaces that bear against the piston 52 within the sockets 62 and facilitate pivoting of each of the seal ring carriers 58 (and the carried seal rings 56), independently of the others, with respect to the piston 52. The integral bearings can take various forms, but are depicted as rounded ends 84 in FIG. 8 and bulging ends 86 in FIG. 9 as two examples. The seal rings 56 are received within bores of the seal ring carriers 58 in the embodiments of FIGS. 7 and 8, but in other instances the seal rings 56 include bores that receive protruding portions of the seal ring carriers 58, such as depicted in FIG. 9. In at least some embodiments, the integral bearing portions of the seal ring carriers 58 of FIGS. 8 and 9 allow three degrees of rotational freedom of the seal ring carriers 58. But like the bearings 80 of FIG. 7, integral bearing portions of the seal ring carriers 58 could provide fewer degrees of rotational freedom in other embodiments.

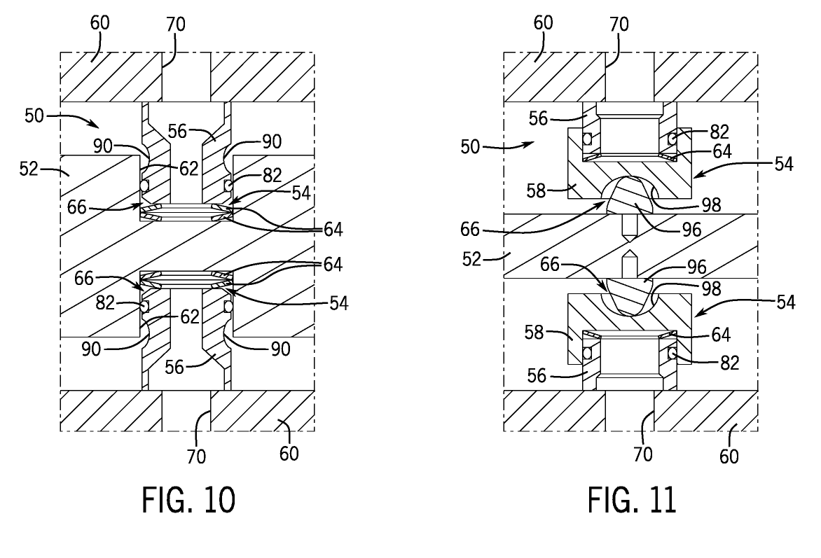

In another embodiment generally depicted in FIG. 10, the seal ring assemblies 54 include seal rings 56 that are installed in sockets 62 of the piston 52 without seal ring carriers 58. The seal rings 56 are sized to provide clearance between the sockets 62 and the exteriors of the ends of the seal rings 56 received in the sockets 62 (i.e., at joints 66) to facilitate pivoting of the seal rings 56 in a manner like that described above with respect to the pivoting seal ring carriers 58. The seal rings 56 are biased away from the piston 52 by springs 64. Although depicted as disc springs in FIG. 10, any suitable springs 64 may be used for biasing the seal rings 56 in the various embodiments described herein.

Seals 82 prevent fluid leakage along the exterior of the seal rings 56 while allowing the seal rings 56 to pivot within the sockets 62. Further, the exterior of the seal rings 56 can include one or more recessed portions 90, such as circumferential grooves, to allow a greater range of pivoting motion for the seal rings 56. That is, in contrast to seal rings having straight cylindrical exteriors, the presence of the recessed portions 90 in alignment with the ends of the sockets 62 at the exterior of the piston 52 facilitate pivoting by allowing the recessed portions 90 to receive the outer edges of the sockets 62 (i.e., the edges closest to the seal plates 60) when the seal rings 56 pivot within the sockets 62.

In still another embodiment generally depicted in FIG. 11, the seal rings 56 can pivot via joints 66 provided by hubs 96 protruding from the exterior of the piston 52 and seal ring carriers 58 having recessed portions 98 for receiving the hubs 96. The seal rings 56 are carried by the seal ring carriers 58 and biased outward from the piston 52 by springs 64, as discussed above. The recessed portions 98 of the seal ring carriers 58 bear against the hubs 96 and allow the seal ring carriers 58 (and their carried seal rings 56) to pivot about the hubs 96. In at least some embodiments, the hubs 96 and the recessed portions 98 are rounded so as to allow three degrees of rotational freedom, but other configurations could be used to provide fewer degrees of rotational freedom.

From the foregoing description, it will be appreciated that by using the piston 52 to move the seal ring assemblies 54 and allowing the seal ring assemblies 54 to articulate independent of the other seal ring assemblies 54, the seal rings 56 may have increased acceptable angles of misalignment. The increased acceptable misalignment may facilitate proper internal sealing of the pressure regulator 40 (e.g., of the seal rings 56 against seal plates 60) with larger part machine tolerancing, which may allow reductions in individual part costs. In compensating for misalignment, the use of articulating seal ring assemblies 54 in some instances could also help to reduce or avoid certain wear or damage, such as from high contact point loading from binding of internal components during high-velocity dynamic operation.

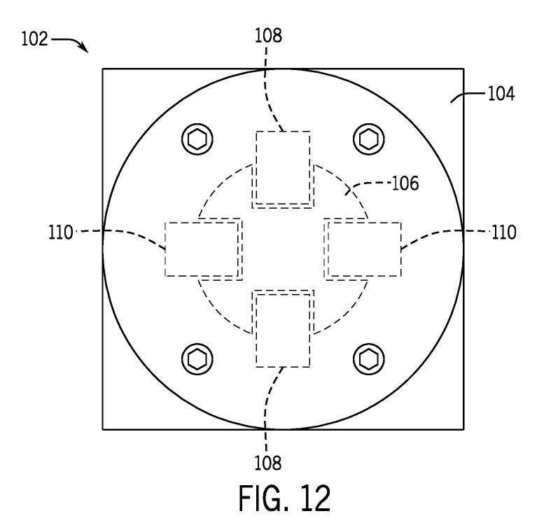

Finally, the use of articulated seal ring assemblies in a valve may facilitate valve configurations in which some articulated seal ring assemblies are rotationally offset from others such that seal rings of the articulated seal ring assemblies are biased away from a piston in more than two directions. For example, as generally depicted in FIG. 12, a valve 102 (e.g., a pressure regulator or a control valve) can include a hollow body 104 having an inner chamber in which a piston 106 is disposed. The depicted piston 106 can move axially within the hollow body 104 and carries a first pair of articulated seal ring assemblies 108 and a second pair of articulated seal ring assemblies 110 for controlling flow through the hollow body 104 (e.g., via seal rings 56 sliding along and sealing against seal plates 60). The articulated seal ring assemblies 108 and 110 can take any suitable form, such as any of the various seal ring assemblies 54 described above.

The first pair of articulated seal ring assemblies 108 are positioned on the piston 106 opposite one another with their seal rings biased apart toward sealing surfaces within the hollow body 104. The second pair of articulated seal ring assemblies 110 are also positioned on the piston 106 opposite one another but are rotationally offset ninety degrees about the piston 106 with respect to the first pair of articulated seal ring assemblies 108 such that the seal rings of the second pair of articulated seal ring assemblies 110 are biased apart from one another in directions generally transverse to those in which the seal rings of the first pair of articulated seal ring assemblies 108 are biased. In such an arrangement, the articulated seal ring assemblies 108 can each seal against opposing surfaces within the hollow body 104, such as two opposing seal plates, while the articulated seal ring assemblies 110 can each seal against different opposing surfaces within the hollow body 104, such as two additional opposing seal plates. This allows the valve 102 to use offset flow paths, such as one flow path through flow ports in the upper and lower portions of the hollow body 104 in FIG. 12 and another flow path through flow ports in the left and right sides of the hollow body 104. In this arrangement, the piston 106 can move to control flow through the upper and lower flow ports via seal rings of the articulated seal ring assemblies 108 and to control flow through the left and right flow ports via seal rings of the articulated seal ring assemblies 110. The use of additional sealing surfaces within the valve 102 (e.g., along four sides of the inner chamber, rather than just two sides) can increase the number of misaligned components but, in contrast to unarticulated seal ring assemblies, the articulated seal ring assemblies 108 and 110 can pivot independently to compensate for such misalignment with respect to the additional sealing surfaces.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. An apparatus comprising:
a valve including:
a hollow body having an inlet port and an outlet port in fluid communication with an inner chamber of the hollow body;
a piston disposed within the inner chamber of the hollow body; and
an articulated seal ring assembly carried by the piston, the articulated seal ring assembly including a shear seal ring that is seated against an interior surface within the hollow body and is coupled to the piston via a joint that facilitates pivoting of the shear seal ring with respect to the piston.

2. The apparatus of claim 1, wherein the articulated seal ring assembly includes a seal ring carrier and the shear seal ring is coupled to the piston via the seal ring carrier.

3. The apparatus of claim 2, wherein the joint facilitates pivoting of the shear seal ring with respect to the piston by facilitating pivoting of the seal ring carrier with respect to the piston.

4. The apparatus of claim 3, wherein the joint includes a bearing installed between the seal ring carrier and the piston so as to facilitate pivoting of the seal ring carrier about the bearing.

5. The apparatus of claim 4, wherein the bearing is a ball bearing.

6. The apparatus of claim 4, wherein the bearing is a hub protruding from an outer surface of the piston.

7. The apparatus of claim 3, wherein the seal ring carrier is received in a socket of the piston and the seal ring carrier includes a curved surface that bears against the piston within the socket and that facilitates pivoting of the seal ring carrier with respect to the piston within the socket.

8. The apparatus of claim 1, wherein the valve includes an additional articulated seal ring assembly carried by the piston, and the additional articulated seal ring assembly includes an additional shear seal ring that is seated against an additional interior surface within the hollow body and is coupled to the piston via an additional joint that facilitates pivoting of the additional shear seal ring with respect to the piston.

9. The apparatus of claim 8, wherein the articulated seal ring assembly and the additional articulated seal ring assembly are disposed on opposite sides of an axis of travel of the piston within the hollow body.

10. The apparatus of claim 1, wherein the hollow body includes a seal plate having at least part of the inlet port, at least part of the outlet port, and the interior surface against which the shear seal ring is seated.

11. An apparatus comprising:
a valve including:
a hollow body; and
a carriage assembly that includes shear seal rings and is received in the hollow body so as to allow reciprocal movement of the carriage assembly with the shear seal rings along an axis within the hollow body, wherein the shear seal rings include a first shear seal ring and a second shear seal ring each biased away from the axis so as to seal against an opposing surface within the hollow body, and the first and second shear seal rings are carried so as to allow the first and second shear seal rings to pivot independent of one another to facilitate sealing of the first and second shear seal rings against the opposing surface within the hollow body.

12. The apparatus of claim 11, wherein the first and second shear seal rings are received in sockets of a piston of the carriage assembly, the first and second shear seal rings and the sockets are configured to facilitate pivoting of the first and second shear seal rings with respect to the piston within the sockets, and the exterior of each of the first and second shear seal rings has a recess for receiving an edge of the socket of the piston in which the first or second shear seal ring is received so as to increase the range of pivoting motion of the first and second shear seal rings with respect to the piston within the sockets.

13. The apparatus of claim 11, wherein the first and second shear seal rings are positioned such that the first shear seal ring is biased away from the axis so as to seal against a first opposing surface within the body and the second shear seal ring is biased away from the axis so as to seal against a second opposing surface within the body, and the first and second opposing surfaces are on opposite sides of a cavity in the hollow body in which the carriage assembly is received.

14. The apparatus of claim 13, wherein the shear seal rings include third and fourth shear seal rings carried so as to allow each of the first shear seal ring, the second shear seal ring, the third shear seal ring, and the fourth shear seal ring to pivot independent of one another.

15. The apparatus of claim 14, wherein the third and fourth shear seal rings are positioned such that the third and fourth shear seal rings are biased away from the axis and away from each other, and the third and fourth shear seal rings are rotationally offset with respect to the first and second shear seal rings such that the third and fourth shear seal rings do not seal against either of the first or second opposing surfaces within the body.

16. The apparatus of claim 11, wherein the carriage assembly includes a hydraulic piston.

17. The apparatus of claim 11, comprising a blowout preventer control system including the valve.

18. A method comprising:
receiving, within a hollow valve body, a piston carrying first and second seal ring assemblies;
pivoting the first seal ring assembly with respect to the piston to facilitate sealing engagement of a shear seal ring of the first seal ring assembly against an interior surface within the hollow valve body; and
pivoting the second seal ring assembly with respect to the piston to facilitate sealing engagement of a shear seal ring of the second seal ring assembly against the interior surface within the hollow valve body or against an additional interior surface within the hollow valve body, wherein pivoting each of the first and second seal ring assemblies is independent of pivoting the other of the first and second seal ring assemblies.

19. The method of claim 18, wherein the shear seal ring of the first seal ring assembly is received in a seal ring carrier of the first seal ring assembly, and pivoting the first seal ring assembly includes pivoting the seal ring carrier of the first seal ring assembly with respect to the piston.

20. The method of claim 19, wherein the shear seal ring of the second seal ring assembly is received in a seal ring carrier of the second seal ring assembly, and pivoting the second seal ring assembly includes pivoting the seal ring carrier of the second seal ring assembly with respect to the piston.
